(19) United States
(12) Patent Application Publication
(10) Pub. No.: US 2017/0186043 A1
(43) Pub. Date: Jun. 29, 2017

(54) ADVERTISEMENT RECOMMENDATION METHOD AND BASED ON FACE RECOGNTION AND RECOGNITION AND ELECTRONIC DEVICE

(71) Applicants: Le Holdings (Beijing) Co., Ltd., Beijing (CN); Le Shi Zhi Xin Electronic Technology (Tianjin) Limited, Binhai New Area (CN)

(72) Inventor: Feng Pan, Binhai New Area (CN)

(21) Appl. No.: 15/240,273

(22) Filed: Aug. 18, 2016

Related U.S. Application Data
(63) Continuation of application No. PCT/CN2016/089581, filed on Jul. 10, 2016.

(30) Foreign Application Priority Data
Dec. 29, 2015 (CN) 201511028354.8

(51) Int. Cl. G06Q 30/02; G06K 9/00

(52) U.S. Cl. CPC G06Q 30/0269; G06K 9/00228; G06K 9/00288

(57) ABSTRACT

Embodiments of the present disclosure disclose an advertisement recommendation method and apparatus based on face recognition. A face detection process is initiated, and face data is acquired; identity information of a user is acquired in a preset face and user table according to the face data; and the acquired identity information is uploaded to a server, and an advertisement file that is recommended according to a watching history of the user is received from the server; when the watching history does not exist, in a process of playing a video file, it is determined whether the played video file is an advertisement video file; when a determining result indicates that the played video file is an advertisement video file, playing time length of the advertisement file is monitored; if it is monitored that the playing time length meets a preset condition, the advertisement file is marked as an effective watching history; and the acquired identity information and the effective watching history are uploaded to the server according to the identity information of the user. Therefore, the advertisement recommendation method and apparatus based on face recognition resolve the problem that an advertisement cannot be accurately delivered to each user.

### CROSS-REFERENCE TO RELATED APPLICATIONS

The present disclosure claims priority to Chinese Patent Application No. 201511028354.8, filed with the Chinese Patent Office on Dec. 29, 2015 and entitled “ADVERTISEMENT RECOMMENDATION METHOD AND APPARATUS BASED ON FACE RECOGNITION”, which is incorporated herein by reference in its entirety.

### TECHNICAL FIELD

The present disclosure relates to the field of media communication, and in particular, to an advertisement recommendation method and apparatus based on face recognition.

### BACKGROUND

Nowadays, the smart television is an intelligent multimedia terminal that emerges with the trend of televisions developing towards high definition, networking, and intelligence, and is equipped with capabilities of obtaining program content via many channels such as the Internet, a video device, and a computer, and presenting content that is most needed by a consumer on a screen through an integrated operation interface that is simple and easy to use.

In the highly competitive modern commercial environment, for a long time, on one hand, accurate delivering of advertisements is advocated, and on the other hand, advertisement delivery targets are determined by simply relying on experience, and consumers are labeled with fixed labels such as conventional age or gender, and advertisements are delivered according to watching statuses of the consumers. In fact, whether the consumers actually intend to buy a product, and whether the advertisements can cover consumers intending to buy the product more accurately in other periods are not known. Therefore, the selection of advertising periods entirely runs counter to the target of accurate delivery.

### SUMMARY

In view of this, an objective of some embodiments of the present disclosure is to provide an advertisement recommendation method and apparatus based on face recognition, which resolve the problem that an advertisement cannot be accurately delivered to each user.

Based on the foregoing objective, the advertisement recommendation method based on face recognition provided in some embodiments of the present disclosure includes steps:

initiating a face detection process, and acquiring face data;

acquiring identity information of a user in a preset face and user table according to the face data, where the face and user table stores a correspondence between face data and identity information of each user; and

uploading the acquired identity information to a server, and receiving, from the server, an advertisement file that is recommended according to a watching history of the user; when the watching history does not exist, in a process of playing a video file, determining whether the played video file is an advertisement video file; when a determining result indicates that the played video file is an advertisement video file, monitoring playing time length of the advertisement file; if it is monitored that the playing time length meets a preset condition, marking the advertisement file as an effective watching history; and uploading the acquired identity information and the effective watching history to the server according to the identity information of the user.

In an embodiment, when the playing time length of the advertisement file is monitored, whether a watcher exists in front of a screen is monitored; and

if it is monitored that the playing time length meets the preset condition, it is determined whether it is continuously monitored, during the playing time length, that the watcher exists in front of the screen, and if yes, the advertisement file is marked as an effective watching history, otherwise the advertisement file is not marked as an effective watching history.

In an embodiment, when it is not continuously monitored, during the playing time length, that the watcher exists in front of the screen, it is determined whether time length during which the watcher does not exist in front of the screen is great than a preset away time threshold, and if no, the advertisement file is marked as an effective watching history, otherwise the advertisement file is not marked as an effective watching history.

In an embodiment, in the monitoring whether the playing time length meets a preset condition, the preset condition is:

when a difference between the playing time length and total time length of the advertisement file does not reach a preset maximum difference threshold, the advertisement file is marked as an effective watching history.

In an embodiment, before the initiating the face detection process, the method further includes: acquiring an instruction, from the user, for logging into a smart television account, or receiving an instruction that is triggered when the user clicks on a video file after logging into the smart television account.

In another aspect, some embodiments of the present disclosure further provide an advertisement recommendation apparatus based on face recognition, including:

a face data acquisition unit, configured to initiate a face detection process and acquire face data;

an identity information acquisition unit, configured to acquire identity information of a user in a preset face and user table according to the face data, where the face and user table stores a correspondence between face data and identity information of each user; and

a video file recommendation unit, configured to: upload the acquired identity information to a server, and receive, from the server, an advertisement file that is recommended according to a watching history of the user; when the watching history does not exist, in a process of playing a video file, determine whether the played video file is an advertisement video file; when a determining result indicates that the played video file is an advertisement video file, monitor playing time length of the advertisement file; if it is monitored that the playing time length meets a preset condition, mark the advertisement file as an effective watching history; and upload the acquired identity information and the effective watching history to the server according to the identity information of the user.

In an embodiment, the video file recommendation unit is further configured to: when the playing time length of the advertisement file is monitored, monitor whether a watcher exists in front of a screen; and

if it is monitored that the playing time length meets the preset condition, determine whether it is continuously monitored, during the playing time length, that a watcher exists in front of the screen, and if yes, mark the advertisement file as an effective watching history, otherwise skip marking the advertisement file as an effective watching history.

In an embodiment, the video file recommendation unit is further configured to: when it is not continuously monitored, during the playing time length, that the watcher exists in front of the screen, determine whether time length during which the watcher does not exist in front of the screen is great than a preset away time threshold, and if no, mark the advertisement file as an effective watching history, otherwise skip marking the advertisement file as an effective watching history.

In an embodiment, the video file recommendation unit monitors whether the playing time length meets a preset condition, and the preset condition is:

when a difference between the playing time length and total time length of the advertisement file does not reach a preset maximum difference threshold, the advertisement file is marked as an effective watching history.

In an embodiment, before initiating the face detection process, the face data acquisition unit is further configured to: acquire an instruction, from the user, for logging into a smart television account, or receive an instruction that is triggered when the user clicks on a video file after logging into the smart television account.

It can be seen from the foregoing description that, according to the advertisement recommendation method and apparatus based on face recognition provided in the embodiments of the present disclosure, a face detection process is initiated, and face data is acquired, and identity information of a user is acquired in a preset face and user table according to the face data. The acquired identity information is uploaded to a server, and an advertisement file that is recommended according to a watching history of the user is received from the server. When the watching history does not exist, in a process of playing a video file, it is determined whether the played video file is an advertisement video file. When a determining result indicates that the played video file is an advertisement video file, playing time length of the advertisement file is monitored; if it is monitored that the playing time length meets a preset condition, the advertisement file is marked as an effective watching history; and the acquired identity information and the effective watching history are uploaded to the server according to the identity information of the user. Thereby, personalized and accurate advertisement recommendation for each user is implemented, and quality of advertisement services for a smart television is optimized.

### BRIEF DESCRIPTION OF THE DRAWINGS

FIG. 1 is a schematic flowchart of an advertisement recommendation method based on face recognition according to an embodiment of the present disclosure;

FIG. 2 is a schematic flowchart of an advertisement recommendation method based on face recognition according to a referable embodiment of the present disclosure; and

FIG. 3 is a schematic structural diagram of an advertisement recommendation apparatus based on face recognition according to some embodiments of the present disclosure.

### DETAILED DESCRIPTION

To make the objectives, technical solutions, and advantages of some embodiments of the present disclosure clearer, the present disclosure is described in further detail in combination with specific embodiments with reference to the accompanying drawings.

According to use status of smart televisions, for advertisement delivery, delivery targets are determined by simply relying on experience, and advertisements cannot be delivered according to real interests of each user. To resolve this problem, in some embodiment of the present disclosure, from the perspective of a user, it is realized that the user desires that only advertisement files in which the user is interested are recommended to the user. Therefore, an idea of some embodiments of the present disclosure is establishing interconnection among face recognition, advertisement files, and personalized recommendation on a smart television.

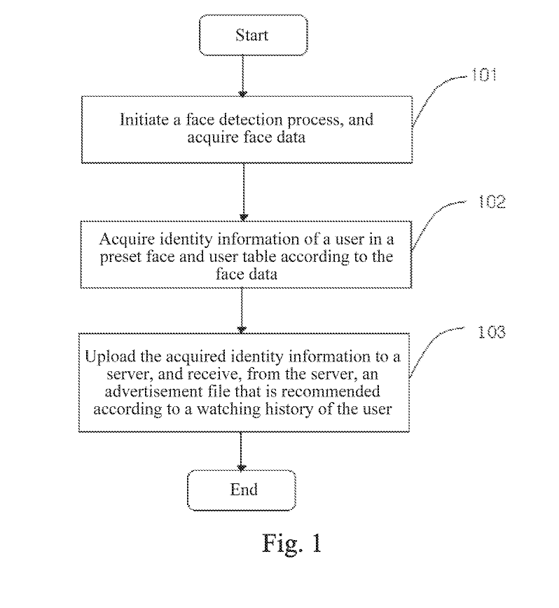

Refer to FIG. 1, which is a schematic flowchart of an advertisement recommendation method based on face recognition according to some embodiments of the present disclosure. The advertisement recommendation method based on face recognition includes:

Step 101: Initiate a face detection process, and acquire face data.

After an instruction, from a user, for logging into a smart television account is acquired, the face detection process may be initiated. Alternatively, the face detection process may be initiated after an instruction that is triggered when the user clicks on a video file after logging into the smart television account is received.

The smart television account refers to an account for an entire family that is set on a smart television. First the user may log into the account through verification of the family account, then different users logging into the family account are recognized by initiating the face detection process. Thereby, multiple users sharing the same family account may be recognized.

In addition, the face detection process is set to be resident in a system, and is a background process keeping running by default.

Step 102: Acquire identity information of the user in a preset face and user table according to the face data.

In this embodiment, the face and user table stores a correspondence between face data and identity information of each user. The identity information may include a user name, a password, a gender, an age, and the like.

It is to be noted that, before the identity information of the user is acquired in the preset face and user table, whether the identity information of the user exists in the preset face and user table may be determined according to the face data. If the identity information exists, the identity information is acquired, otherwise the identity information of the user corresponding to the face data is created in the face and user table. For example, a floating window may be popup for the user to set the identity information by himself/herself, and the set identity information and the face data are corresponded and stored into face and user table. Preferably, an updated face and user table is uploaded to a server.

In this embodiment, each family account is corresponding to a face and user table, where the face and user table stores a correspondence between face data and identity information of each user logging into the family account. Alternatively, the face and user table stores correspondences between face data and identity information of all users, which include correspondences between face data and identity information of users that undergo face detection after logging into a same family account, and also include correspondences between face data and identity information of users that undergo face detection after logging into different family accounts.

In this embodiment, when the face and user table stores the correspondences between the face data and the identity information of all the users, the face and user table may also store a family account identifier. That is, a family account identifier is further set in the correspondence between the face data and the identity information of each user, where family account identifiers of multiple users logging into a same family account are the same.

In addition, the face and user table may be stored locally, or may not be stored locally. However, whether the face and user table is stored locally or not, the face and user table is stored in the server end. Preferably, if the face and user table is not stored locally, the face and user table currently stored in the server may be obtained by sending a request to the server through a network by using a current local MAC address as a parameter.

Step 103: Upload the acquired identity information to a server, and receive, from the server, an advertisement file that is recommended according to a watching history of the user.

In some embodiments of the present disclosure, when the watching history does not exist, in a process of playing a video file, it is determined whether the played video file is an advertisement video file. When a determining result indicates that the played video file is an advertisement video file, playing time length of the advertisement file is monitored. If it is monitored that the playing time length meets a preset condition, the advertisement file is marked as an effective watching history; and the acquired identity information and the effective watching history are uploaded to the server according to the identity information of the user. Preferably, the preset condition is: a difference between the playing time length and total time length of the advertisement file does not reach a preset maximum difference threshold. The playing time length is a total time of an already played part of the video file. In addition, a reason for the case that the playing time length of the video file does not reach total time length of the video may be, for example, changing a channel or shutting down by the user.

For example, the preset maximum difference threshold may be one second, that is, if the difference between the playing time length and the total time length of the advertisement file does not reach one second, the advertisement file is marked as an effective watching history.

In this embodiment, the acquired identity information and the effective watching history may be uploaded to the server by using the current local MAC address as a parameter.

It can be seen from this embodiment that, according to the advertisement recommendation method based on face recognition, not only marking an advertisement file can be implemented, but also the marked advertisement file is ensured to be an advertisement file in which the user is interested, which provides a basis for recommending an advertisement file to the user.

In this embodiment, when the playing time length of the advertisement file is monitored, whether a watcher exists in front of a screen is monitored. If it is monitored that the playing time length meets the preset condition, it is determined whether it is continuously monitored, during the playing time length, that the watcher exists in front of the screen, and if yes, the advertisement file is marked as an effective watching history, otherwise the advertisement file is not marked as an effective watching history. Therefore, an advertisement file that keeps playing but is not watched may be excluded from an effective watching history, which thereby actually achieving that a marked advertisement file is an effective watching history.

Further, when it is not continuously monitored, during the playing time length, that the watcher exists in front of the screen, it is determined whether time length during which the watcher does not exist in front of the screen is great than a preset away time threshold, and if no, the advertisement file is marked as an effective watching history, otherwise the advertisement file is not marked as an effective watching history. For example, in a process of playing the advertisement file, it is monitored that the watcher in front of the screen intermittently exists, but total time length during which the watcher does not exist is 10 seconds, and the preset away time threshold is 11 seconds, then the time length during which the watcher does not exist in front of the screen does not exceed the preset away time threshold, and the advertisement file is marked as an effective watching history. A reason for the case that the watcher does not exist in front of the screen intermittently may be, for example, that the watcher temporarily leaves to bring something, checks a mobile phone, or talks with someone. Therefore, according to the embodiment, a case in which the watcher temporarily leaves due to some accidental events, but the user is interested in the advertisement file may be taken into consideration.

In this embodiment, when it is monitored whether the watcher in front of the screen exists, a central position in a face image may be obtained by analyzing characteristics of a face in the face image. Then, the current central position and an initial central position before the first time interval are compared to obtain a movement displacement. Preferably, eye pupils are used as a reference for determining the central position of the face.

Specifically, a pupil distance is calculated according to positions of the pupils, and a position of a central point between the pupils is determined as the central position. By using a middle point between eyes as the central position of the face, a position of the face can be better determined to determine a displacement of the watcher, and whether the watcher in front of the screen is watching the played advertisement file can be determined more accurately. Certainly, the central position of the face may also be determined in another manner, for example, selecting an outline of the entire face, and determining a center of the outline by means of calculation.

In this embodiment, if the watcher in front of the screen lowers the head, it may also be determined that the watcher is not interested in the played advertisement file. Specifically, after the pupil distance is calculated according to the positions of the pupils, the following operations may further be included: comparing the current pupil distance and an initial pupil distance before a second time interval to obtain a ratio. If the ratio is great than a preset pupil distance threshold, it is determined that the watcher lowers the head. The ratio is a ratio that is obtained by using the current pupil distance as a numerator, and the pupil distance before the second time interval is used as a denominator.

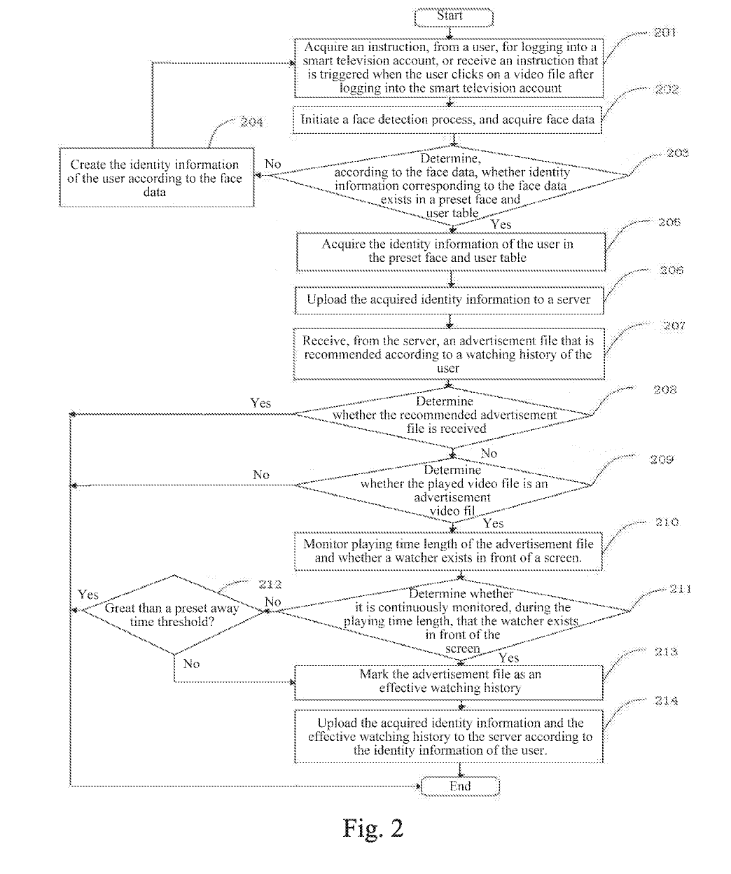

As a referable embodiment, referring to FIG. 2, the advertisement recommendation method based on face recognition may specifically include the following steps.

Step 201: Acquire an instruction, from a user, for logging into a smart television account, or receive an instruction that is triggered when the user clicks on a video file after logging into the smart television account.

Step 202: Initiate a face detection process, and acquire face data.

Step 203: Determine, according to the face data, whether identity information corresponding to the face data exists in a preset face and user table. If the face data exists, proceed to step 205, otherwise proceed to step 204.

Step 204: Create the identity information of the user according to the face data. Then return to step 201.

Step 205: Acquire the identity information of the user in the preset face and user table. Then proceed to step 206.

Step 206: Upload the acquired identity information to a server.

Step 207: Receive, from the server, an advertisement file that is recommended according to a watching history of the user.

Step 208: Determine whether the recommended advertisement file is received. If the recommended advertisement file is received, exit the process, otherwise proceed to step 209.

Step 209: In a process of playing a video file, determine whether the played video file is an advertisement video file. If yes, proceed to step 210, otherwise exit the process.

Step 210: Monitor playing time length of the advertisement file and whether a watcher exists in front of a screen.

Step 211: If it is monitored that the playing time length meets the preset condition, determine whether it is continuously monitored, during the playing time length, that the watcher exists in front of the screen. If yes, proceed to step 213, otherwise proceed to step 212.

In this embodiment, the preset condition may be: a difference between the playing time length and total time length of the advertisement file does not reach a preset maximum difference threshold.

Step 212: Determine whether time length during which the watcher does not exist in front of the screen is great than a preset away time threshold. If no, proceed to step 213, otherwise exit the process.

Step 213: Mark the advertisement file as an effective watching history.

Step 214: Upload the acquired identity information and the effective watching history to the server according to the identity information of the user.

It is worth noting that, step 209 to step 214 not only may be triggered when the recommended advertisement file is not received, but also may be performed after an instruction that is triggered when the user clicks on a video file after logging into the smart television account is received.

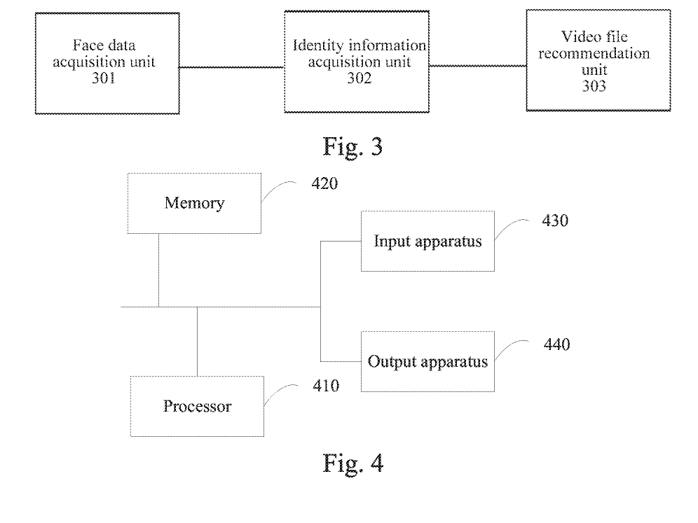

Some embodiments of the present disclosure further provide an advertisement recommendation apparatus based on face recognition. As shown in FIG. 3, the advertisement recommendation apparatus based on face recognition includes a face data acquisition unit 301, an identity information acquisition unit 302, and a video file recommendation unit 303 that are sequentially connected. The face data acquisition unit 301 is configured to initiate a face detection process and acquire face data. The identity information acquisition unit 302 is configured to acquire identity information of a user in a preset face and user table according to the face data. The video file recommendation unit 303 is configured to upload the acquired identity information to a server, and receive, from the server, an advertisement file that is recommended according to a watching history of the user.

It is to be noted that, the face and user table stores a correspondence between face data and identity information of each user.

In this embodiment, before initiating the face detection process, the face data acquisition unit 301 acquires an instruction, from the user, for logging into a smart television account, or receives an instruction that is triggered when the user clicks on a video file after logging into the smart television account. Preferably, the face data acquisition unit 301 sets the face detection process to be resident in a system, and the face detection process is a background process keeping running by default.

In this embodiment, when the watching history does not exist, in a process of playing a video file, the video file recommendation unit 303 determines whether the played video file is an advertisement video file. When a determining result indicates that the played video file is an advertisement video file, playing time length of the advertisement file is monitored. If it is monitored that the playing time length meets a preset condition, the advertisement file is marked as an effective watching history; and the acquired identity information and the effective watching history are uploaded to the server according to the identity information of the user. Preferably, the preset condition is: a difference between the playing time length and total time length of the advertisement file does not reach a preset maximum difference threshold. For example, the preset maximum difference threshold may be one second, that is, if the difference between the playing time length and the total time length of the advertisement file does not reach one second, the advertisement file is marked as an effective watching history. In addition, the acquired identity information and the effective watching history may be uploaded to the server by using the current local MAC address as a parameter.

In this embodiment, when the playing time length of the advertisement file is monitored, whether a watcher exists in front of a screen is monitored. If it is monitored that the playing time length meets the preset condition, it is determined whether it is continuously monitored, during the playing time length, that a watcher exists in front of the screen, and if yes, the advertisement file is marked as an effective watching history, otherwise the advertisement file is not marked as an effective watching history. Further, when it is not continuously monitored, during the playing time length, that a watcher exists in front of the screen, it is determined whether time length during which a watcher does not exist in front of the screen is great than a preset away time threshold, and if no, the advertisement file is marked as an effective watching history, otherwise the advertisement file is not marked as an effective watching history.

It is to be noted that, specific implementation content for the advertisement recommendation apparatus based on face recognition in some embodiments of the present disclosure has been described in detail in the foregoing advertisement recommendation method based on face recognition, and therefore the repeated content is not described herein again.

To sum up, according to the advertisement recommendation method and apparatus based on face recognition provided in some embodiments of the present disclosure, the problem of inflexibility of advertisement recommendation services for a smart television is creatively resolved, and diversity of the recommendation services are achieved; an advertisement can be accurately recommended according to preferences of a user; and finally, the entire advertisement recommendation method and apparatus based on face recognition are compact and easy to implement.

It should be understood by a person of ordinary skill in the art that, what is described above is merely specific embodiments of the present disclosure, and is not intended to limit the present disclosure, and any modification, equivalent replacement, and improvement shall be included within the protection scope of the present disclosure without departing from the spirit and principle of the present disclosure.

1. An advertisement recommendation method based on face recognition, applied to a terminal, comprising steps:
initiating a face detection process, and acquiring face data;
acquiring identity information of a user in a preset face and user table according to the face data, wherein the face and user table stores a correspondence between face data and identity information of each user; and
uploading the acquired identity information to a server, and receiving, from the server, an advertisement file that is recommended according to a watching history of the user; when the watching history does not exist, in a process of playing a video file, determining whether the played video file is an advertisement video file; when a determining result indicates that the played video file is an advertisement video file, monitoring playing time length of the advertisement file; if it is monitored that the playing time length meets a preset condition, marking the advertisement file as an effective watching history; and uploading the acquired identity information and the effective watching history to the server according to the identity information of the user.

2. The method according to claim 1, wherein when the playing time length of the advertisement file is monitored, whether a watcher exists in front of a screen is monitored; and
if it is monitored that the playing time length meets the preset condition, it is determined whether it is continuously monitored, during the playing time length, that the watcher exists in front of the screen, and if yes, the advertisement file is marked as an effective watching history, otherwise the advertisement file is not marked as an effective watching history.

3. The method according to claim 2, wherein when it is not continuously monitored, during the playing time length, that the watcher exists in front of the screen, it is determined whether time length during which the watcher does not exist in front of the screen is great than a preset away time threshold, and if no, the advertisement file is marked as an effective watching history, otherwise the advertisement file is not marked as an effective watching history.

4. The method according to claim 1, wherein in the monitoring whether the playing time length meets a preset condition, the preset condition is:
when a difference between the playing time length and total time length of the advertisement file does not reach a preset maximum difference threshold, the advertisement file is marked as an effective watching history.

5. The method according to claim 1, wherein before the initiating the face detection process, the method further comprises: acquiring an instruction, from the user, for logging into a smart television account, or receiving an instruction that is triggered when the user clicks on a video file after logging into the smart television account.

6-10. (canceled)

11. A non-volatile computer storage medium, which stores a computer executable instruction, that when executed by an electronic device, cause the electronic device to:
initiate a face detection process, and acquire face data;
acquire identity information of a user in a preset face and user table according to the face data, wherein the face and user table stores a correspondence between face data and identity information of each user; and
upload the acquired identity information to a server, and receive, from the server, an advertisement file that is recommended according to a watching history of the user; when the watching history does not exist, in a process of playing a video file, determine whether the played video file is an advertisement video file; when a determining result indicates that the played video file is an advertisement video file, monitor playing time length of the advertisement file; if it is monitored that the playing time length meets a preset condition, mark the advertisement file as an effective watching history; and
upload the acquired identity information and the effective watching history to the server according to the identity information of the user.

12. The non-volatile computer storage medium according to claim 11, wherein when the playing time length of the advertisement file is monitored, whether a watcher exists in front of a screen is monitored; and
if it is monitored that the playing time length meets the preset condition, it is determined whether it is continuously monitored, during the playing time length, that the watcher exists in front of the screen, and if yes, the advertisement file is marked as an effective watching history, otherwise the advertisement file is not marked as an effective watching history.

13. The non-volatile computer storage medium according to claim 12, wherein when it is not continuously monitored, during the playing time length, that the watcher exists in front of the screen, it is determined whether time length during which the watcher does not exist in front of the screen is great than a preset away time threshold, and if no, the advertisement file is marked as an effective watching history, otherwise the advertisement file is not marked as an effective watching history.

14. The non-volatile computer storage medium according to claim 11, wherein the instructions to monitor whether the playing time length meets a preset condition, the preset condition is:
when a difference between the playing time length and total time length of the advertisement file does not reach a preset maximum difference threshold, the advertisement file is marked as an effective watching history.

15. The non-volatile computer storage medium according to claim 11, wherein before the instructions to initiate the face detection process, the method further comprises: acquiring an instruction, from the user, for logging into a smart television account, or receiving an instruction that is triggered when the user clicks on a video file after logging into the smart television account.

16. An electronic device, comprising:
at least one processor; and
a memory communicably communication with the at least one processor, wherein
the memory stores instructions executable by the at least one processor, wherein
execution of the instructions by the at least one processor causes the at least one processor to:
initiate a face detection process, and acquire face data;
acquire identity information of a user in a preset face and user table according to the face data, wherein the face and user table stores a correspondence between face data and identity information of each user; and
upload the acquired identity information to a server, and receive, from the server, an advertisement file that is recommended according to a watching history of the user; when the watching history does not exist, in a process of playing a video file, determine whether the played video file is an advertisement video file; when a determining result indicates that the played video file is an advertisement video file, monitor playing time length of the advertisement file; if it is monitored that the playing time length meets a preset condition, mark the advertisement file as an effective watching history; and upload the acquired identity information and the effective watching history to the server according to the identity information of the user.

17. The electronic device according to claim 16, wherein when the playing time length of the advertisement file is monitored, whether a watcher exists in front of a screen is monitored; and
if it is monitored that the playing time length meets the preset condition, it is determined whether it is continuously monitored, during the playing time length, that the watcher exists in front of the screen, and if yes, the advertisement file is marked as an effective watching history, otherwise the advertisement file is not marked as an effective watching history.

18. The electronic device according to claim 17, wherein when it is not continuously monitored, during the playing time length, that the watcher exists in front of the screen, it is determined whether time length during which the watcher does not exist in front of the screen is great than a preset away time threshold, and if no, the advertisement file is marked as an effective watching history, otherwise the advertisement file is not marked as an effective watching history.

19. The electronic device according to claim 16, wherein in the monitoring whether the playing time length meets a preset condition, the preset condition is:
when a difference between the playing time length and total time length of the advertisement file does not reach a preset maximum difference threshold, the advertisement file is marked as an effective watching history.

20. The electronic device according to claim 16, wherein before the initiating the face detection process, the method further comprises: acquiring an instruction, from the user, for logging into a smart television account, or receiving an instruction that is triggered when the user clicks on a video file after logging into the smart television account.
